(19) United States
(12) Patent Application Publication
(10) Pub. No.: US 2020/0039859 A1
(43) Pub. Date: Feb. 6, 2020

(54) MOLD FOR PROCESSING GLASS

(71) Applicant: AAC Technologies Pte. Ltd., Singapore City (SG)

(72) Inventors: Yuqin Yuan, Shenzhen (CN); Xiaogang Zhai, Shenzhen (CN); Wei Su, Shenzhen (CN)

(21) Appl. No.: 16/527,028

(22) Filed: Jul. 31, 2019

(30) Foreign Application Priority Data
Aug. 2, 2018 (CN) 201821244092.8

(51) Int. Cl. C03B 11/08

(52) U.S. Cl. CPC C03B 11/08

(57) ABSTRACT

A mold for processing glass is provided in the present disclosure. The mold for processing a three-dimensional glass substrate comprises a concave mold having a cavity and a convex mold matched with the concave mold. The mold comprises an inner wall enclosing the cavity, the mold for processing glass further comprises a plurality of core molds circumferentially disposed on the convex mold. The plurality of core molds is detachably fixed on the convex mold, the plurality of core molds and the convex mold extends into the cavity, and the plurality of core molds, the convex mold and the inner walls collectively enclose a molding space for forming a three-dimensional glass substrate. The processing mold provided by the present disclosure can ensure the smooth release of the three-dimensional glass substrate and improve the yield.

### FIELD OF THE DISCLOSURE

The present disclosure relates to product processing and product molding, and more particularly to a mold for processing glass.

### DESCRIPTION OF RELATED ART

With the development of the mobile internet era, electronic devices are more and more widely being used, such as mobile phones, tablets, and notebooks. In addition to functionality requirements, user's requirements for industrial product design of electronic devices are also more and more increasingly, for example, electronic devices in the related art, the industrial product design of the electronic devices are increasingly using three-dimensional glass substrates.

In the related art, a processing method of the three-dimensional glass substrate is generally processed by mold-to-glass basically by thermoforming process, and the mold for processing a three-dimensional glass substrate generally comprises a concave mold having a cavity and a convex mold matched with the concave mold. After the concave mold and the convex mold are combined each other, a gap having a predetermined shape is enclosed between the concave mold and the convex mold, thereby utilizing the gap to confine the shape of the glass substrate in the hot-melt state to be molded, and then cooling to form a three-dimensional glass substrate having a predetermined shape.

The processing method of the three-dimensional glass substrate specifically includes the following steps:

Step01, providing a glass plate to be processed sandwiched between a concave mold and a convex mold;

Step02, combined the concave mold to the convex mold in a high temperature environment, wherein the gap between the concave mold and the convex mold is filled with the glass substrate respectively;

Step03, providing a cooling process, and thereby a three-dimensional glass substrate having a predetermined shape is formed.

However, at high temperature, the convex mold is completely adhered to the inner wall surfaces of a three-dimensional glass substrate. After cooling to normal temperature, the three-dimensional glass substrate cannot be detached from the convex mold due to the inverted structure on the three-dimensional glass substrate, resulting in damage of the three-dimensional glass substrate, and the yield is not high.

Therefore, it is desired to provide a mold for processing three-dimensional glass substrates to overcome the aforesaid problems.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure. Moreover, in the drawings, like reference numerals designate corresponding parts throughout the several views.

FIG. 1 is a perspective view of a mold for processing glass according to a first embodiment of the present disclosure;

FIG. 2 is a schematic three-dimensional structural view of a convex mold and loose cores in the mold for processing glass according to the first embodiment of the present disclosure; and

FIG. 3 is a top view of the convex mold and the loose cores in the mold for processing glass according to the first embodiment of the present disclosure.

### DETAILED DESCRIPTION

The present disclosure will hereinafter be described in detail with reference to several exemplary embodiments. To make the technical problems to be solved, technical solutions and beneficial effects of the present disclosure more apparent, the present disclosure is described in further detail together with the figure and the embodiments. It should be understood the specific embodiments described hereby is only to explain the disclosure, not intended to limit the disclosure.

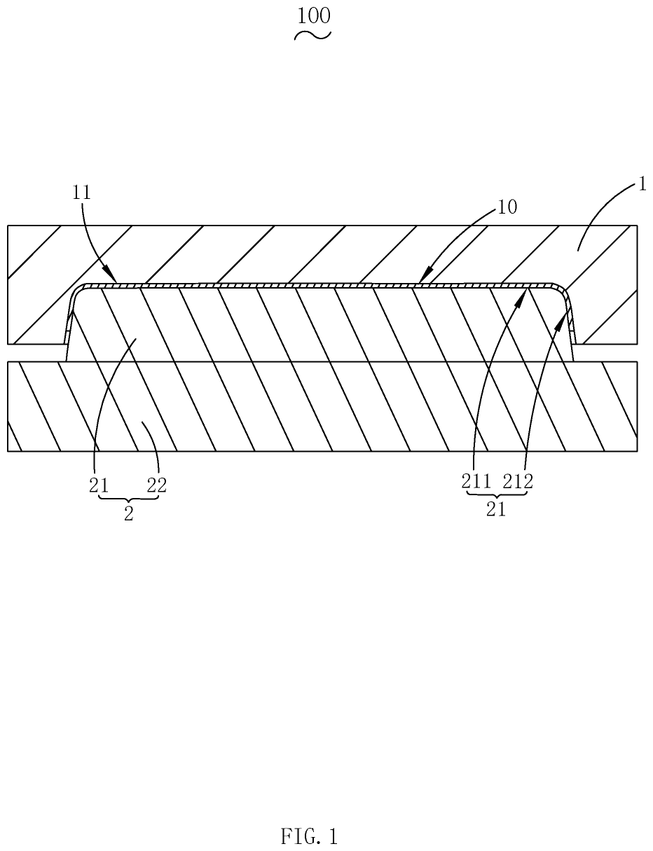

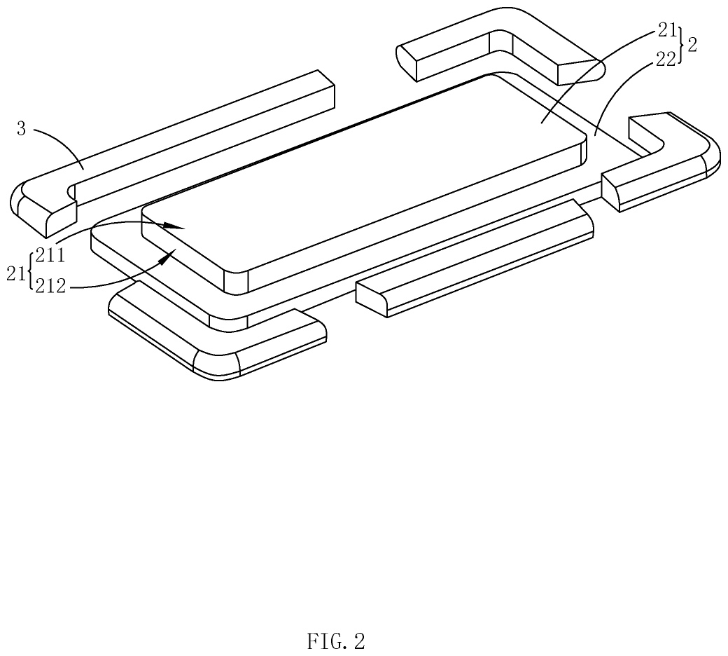

As shown in FIG. 1 and FIG. 2, which is a cross-sectional view of a mold for processing three-dimensional glass substrate provided according to the first embodiment of the present disclosure, and FIG. 2 is a schematic perspective view showing a convex mold and a core of a glass processing mold according to a first embodiment of the present disclosure. The present mold 100 for processing a three dimensional glass substrate comprises a concave mold 1 having a cavity 10, and a convex mold 2 cooperating with the concave mold 1 and a plurality of core molds 3 circumferentially fixed on the convex mold 2. The concave mold 1 comprises an inner wall 11 surrounding the cavity 10 of the concave mold 1. The core mold 3 is detachably fixed on the convex mold 2, and the plurality of core molds 3 and the convex mold 2 extend into the cavity 10. The plurality of core molds 3, the convex mold 2 and the inner wall of the cavity 10 collectively enclose a molding space for molding a three-dimensional glass substrate.

Relative to the related art, in the embodiment of the present , since the amount of undercut of the three-dimensional glass substrate is larger than the gap between the convex mold 2 and the three-dimensional glass substrate, it is difficult for the three-dimensional glass substrate to be released from the convex mold 2.

In the present disclosure, the embodiment of the present disclosure is provided by arranging a plurality of core molds 3 on the convex mold 2, and the plurality of core molds 3 are detachably fixed on the convex mold 2.

In this way, when the three-dimensional glass substrate is released from the convex mold 2, the convex mold 2 can be taken out first to provide the space occupied by the convex mold 2, and then the plurality of core molds 3 are taken out from the space away from the three-dimensional glass substrate, thereby avoiding the aforesaid problems in the related art, thereby ensuring that the three-dimensional glass substrate can be smoothly released and the yield is improved. The friction and collision between the core mold 3 and the inner surface of the three-dimensional glass substrate are avoided, so that the inner surface of the three-dimensional glass substrate is subject to no wear.

Specifically, the convex mold 2 comprises a position-limiting portion 21 and a base 22 fixedly connected to the position-limiting portion 21. The position-limiting portion 21 comprises a top surface 211 rightly facing a bottom of the cavity 10 and a side surface 212 extending from the top surface 211 toward away from the bottom of the cavity 10. The side wall 212 abutting against the base 22, and the core mold 3 is arranged on the side surface 212 of the position-limiting portion 21.

It is worth mentioning that the side surface 212 comprises a plurality of surfaces alternately arranged in sequence, and the joint of at least two adjacent surfaces is provided with a chamfer. The shape of the chamfer can be determined according to the shape of the required glass substrate, and the convex mold 2 can be smoothly extracted from the mold by setting the chamfer, thereby further reducing the difficulty of demolding the three-dimensional glass substrate.

It should be noted that in the present embodiment, the mold 100 for processing the three-dimensional glass substrate further comprises a positioning portion (not shown) that fixes the plurality of core molds 3 to the position-limiting portion 21. According this structure, the core mold 3 does not fall off due to the fixing instability or the positional displacement occurs during the mold clamping, thereby causing the molding of the three-dimensional glass substrate to be affected, and the stability of the mold 100 for processing the glass substrate is further improved.

It can be understood that the positioning portion can be a positioning pin shaft and a pin hole, a screw and a screw hole, and the like. The core mold 3 can be fixed on the position-limiting portion 21, and the structure of the position-limiting portion 21 is prevented from being separated from the core mold 3 during demolding. If the positioning portion is a positioning pin shaft and a pin hole, the positioning pin shaft may be held in the pin hole.

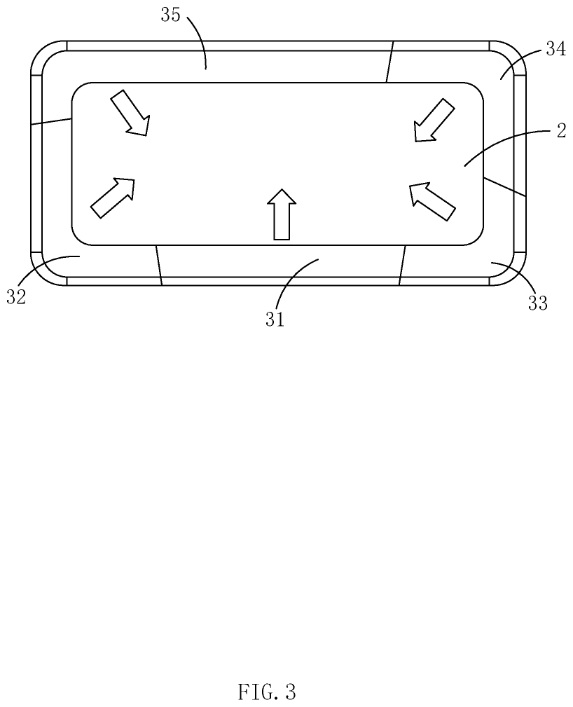

Refer to FIG. 3, which is a plan view of a convex mold and a core mold of a glass processing mold according to a first embodiment of the present disclosure. The disassembly sequence and direction of the convex mold 2 and the core mold 3 in the present embodiment will be specifically described below. The side of the convex mold 2 is completely decomposed into five core molds 3. The number and position of the core molds 3 can be adjusted according to the actual glass shape, and the core mold 3 can be positioned and connected to the base of the convex mold 2 by positioning pins or screws.

The design criteria of the core mold 3 as follows:

(1) easy to take out;

(2) no collision or friction with the side of the glass substrate. In the design of the mold with inverted structure, the convex mold 2 can be fixed on the base 22, and the glass substrate is taken out together with the structure of the core mold 3 when the mold 100 is opened. Then, according to the sequence and direction shown in FIG. 3, the core mold 3 is arranged from the glass substrate in the order of the first core 31, the second core 32, the third core 33, the fourth core 34, and the fifth core 35. The inner side is taken out one by one to realize the smooth demolding of the inverted buckle glass.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mold for processing glass, comprising:
a concave mold having a cavity, the concave mold comprises an inner wall surrounding the cavity of the concave mold;
a convex mold cooperated with the concave mold; and
a plurality of core molds circumferentially fixed on the convex mold, wherein the core mold is detachable, the plurality of core molds and the convex mold extend into the cavity, the plurality of core molds, the convex mold and the inner wall of the cavity collectively enclose into a molding space for molding a three-dimensional glass substrate.

2. The mold for processing glass as described in claim 1, wherein the convex mold comprises a position-limiting portion and a base fixedly connected to the position-limiting portion, the position-limiting portion comprises a top surface facing the bottom of the cavity and a side surface extending from the top surface toward away from the bottom of the cavity, the side wall is connected with the base, and the core mold is surrounded on the side surface of the limiting portion.

3. The mold for processing glass as described in claim 2, wherein the side surface comprises a plurality of surfaces alternately arranged in sequence, and the joint of at least two adjacent surfaces is provided with a chamfer.

4. The mold for processing glass as described in claim 2, wherein the core molds are detachably fixed on the convex mold.

5. The mold for processing glass as described in claim 4, wherein the mold for processing the three-dimensional glass substrate further comprises a positioning portion that fixes the plurality of core molds to the position-limiting portion.

6. The mold for processing glass as described in claim 5, wherein the positioning portion comprises a positioning pin shaft disposed on one of the core mold and the position-limiting portion, and a pin hole disposed on the other of the core mold and position-limiting portion correspondingly.
